(19) United States
(12) Patent Application Publication
(10) Pub. No.: US 2002/0098059 A1
(43) Pub. Date: Jul. 25, 2002

(54) Capped wheel nut

(76) Inventor: Robert Schmidt, Petosky, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 09/767,547

(22) Filed: Jan. 23, 2001

(51) Int. Cl. F16B 23/00; F16B 37/14

(52) U.S. Cl. 411/399

(57) ABSTRACT

A capped wheel nut assembly includes a metal nut and a metal cap oriented on a common axis. The nut has an elongated internally threaded body with a polygonal side wall extending from a first end thereof, toward a second end thereof. The nut has a frusto-conical seat at the second end tapering from a small diameter at a terminus of the second end to a large diameter end proximate to the polygonal side wall of the nut. The large diameter end is greater in diameter than a distance between opposite corners of the side wall of the nut. The nut has an annular recess formed in the frusto-conical seat and the frusto-conical seat defines, at least in part, a seating surface. The cap has an elongated annular side wall of substantially the same polygonal form as the side wall of the nut. The cap as an end wall closing a first end thereof, and is open at a second end thereof. The cap has a first flange extending radially outwardly beyond the side wall of the cap at the open second end of the cap. The cap has a skirt portion axially extending from the first flange in a direct away from the sidewall of the cap. The skirt portion has an internal diameter at least as large as the large diameter end of the frusto-conical seat of the nut. The cap is sleeved over the nut with its side wall surrounding the sidewall of the nut, and its end wall overlying the first end of the nut. An O-ring seal is compressed between the large diameter end and the first flange of the cap to provide an annular seal throughout 360° preventing entry of moisture between the cap and the nut. The skirt is crimped over and pressed against the recessed portion of the frusto-conical surface and the skirt defining at least in part a portion of the seating surface.

### FIELD OF THE INVENTION

This invention relates generally to wheel nut assemblies and more particularly to a wheel nut assembly having a cap secured on a nut.

### BACKGROUND OF THE INVENTION

In the past, capped wheel nut assemblies have been made by welding the cap on the nut. Usually the nut is made of steel with a zinc plate and the cap is stainless steel. A welded joint between the nut and the cap is a corrosive site because of the different metals involved. These corrosive sites lead to weakening or failure of the bond. Elimination of the welded joint eliminates these corrosive sites. Elimination of the welded joint also prevents formation of stress risers in the cap.

As an alternative to a welded joint, an adhesive bond has been employed, of the type disclosed in U.S. Pat. No. 4,764,070. The adhesive bond insulates the two metals from each other and resists corrosion. The adhesive, however, must be capable of retaining its adhesive character over a very wide range of temperatures and also must not break down or allow moisture to enter between the nut and the cap. Moisture leads to corrosion and possible failure.

An alternative assembly, as disclosed in U.S. Pat. No. 6,036,420, employs a technique of crimping a marginal edge portion of the cap over an enlargement on the nut, with an O-ring compressed between and sealingly engaging both the cap and the nut in order to prevent moisture from entering the assembly. The cap's crimped edge is spaced away from the conical seat portion of the nut to prevent the cap from engaging the wheel when the nut is installed. The concern being addressed is that if the cap engages the wheel, the resulting force between the wheel and the cap will tend to dislodge the cap from the nut. However, the spacing of the crimped edge from the conical seat portion may result in an undesirable appearance of the finished nut assembly by requiring the inclusion of a flange portion between the conical seat and the driving or hexagonal portion.

### SUMMARY OF THE INVENTION

A capped wheel nut assembly includes a metal nut and a metal cap oriented on a common axis. The nut has an elongated internally threaded body with a polygonal side wall extending from a first end thereof, toward a second end thereof. The nut has a frusto-conical seat at the second end tapering from a small diameter at a terminus of the second end to a large diameter end proximate to the polygonal side wall of the nut. The large diameter end is greater in diameter than a distance between opposite corners of the side wall of the nut. The nut has an annular recess formed in the frusto-conical seat and the frusto-conical seat defines, at least in part, a seating surface. The cap has an elongated annular side wall of substantially the same polygonal form as the side wall of the nut. The cap as an end wall closing a first end thereof, and is open at a second end thereof. The cap has a first flange extending radially outwardly beyond the side wall of the cap at the open second end of the cap. The cap has a skirt portion axially extending from the first flange in a direct away from the sidewall of the cap. The skirt portion has an internal diameter at least as large as the large diameter end of the frusto-conical seat of the nut. The cap is sleeved over the nut with its side wall surrounding the sidewall of the nut, and its end wall overlying the first end of the nut. An O-ring seal is compressed between the large diameter end and the first flange of the cap to provide an annular seal throughout 360° preventing entry of moisture between the cap and the nut. The skirt is crimped over and pressed against the recessed portion of the frusto-conical surface and the skirt defining at least in part a portion of the seating surface.

The present construction eliminates welding, which leads to corrosion and failure and also to unsightly weld marks which may show through the cap, and also eliminates the problems associated with the manufacture and use of wheel nuts and caps held together by an adhesive bond and eliminates the need for a flange portion between the conical seat and that polygonal side wall of the nut assembly.

One object of this invention is to provide a capped wheel nut assembly having the foregoing features and capabilities.

Another object is to provide a capped wheel nut assembly which is rugged and durable in use and is capable of being inexpensively manufactured and assembled.

These and other objects, features and advantages of the invention will become more apparent as the following description proceeds, especially when considered with the accompanying drawings.

### BRIEF DESCRIPTION OF THE DRAWINGS

FIG. 1 is an exploded view of a capped wheel nut assembly constructed in accordance with this invention.

FIG. 2 is a top plan view of the capped wheel nut assembly.

FIG. 3 is a sectional view taken on the line 3-3 in FIG. 2, with parts broken away and in elevation.

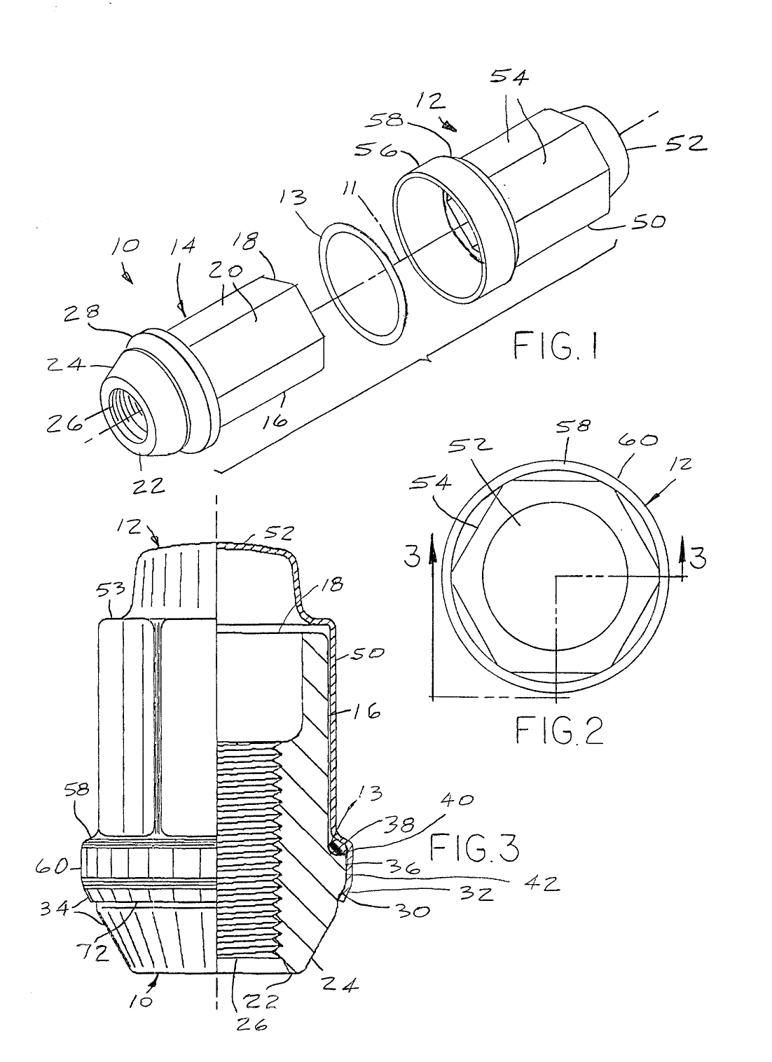

### DETAILED DESCRIPTION OF THE PREFERRED EMBODIMENT

Referring now more particularly to the drawings, the capped wheel nut assembly comprises a wheel nut 10 and a cap 12 centered on an axis 11. An O-ring seal 13 is disposed between the nut 10 and the cap 12.

The wheel nut 10 is in the form of an elongated tubular nut body 14. The nut 10 is formed of steel and has a zinc plating or plate covering it. The body 14 has a main body portion 16 extending from an inner end 18 throughout a major portion of its length. The main body portion 16 has a polygonal side wall. More specifically, it is in the form of a six-sided regular polyhedron in which all six outer surfaces or flats 20 are identical and in which the angles between adjacent flats 20 are all equal. The flats 20 extend parallel to the axis 11 of the tubular body 14.

The nut body 14 is tapered radially outwardly from an outer end 22 toward inner end 18 to provide a frusto-conical seat 24 adapted to engage a complementary seating surface around a bolt on which the nut 10 is threaded. The complementary seating surface is provided by a vehicle wheel. The nut 10 is interiorly threaded where indicated at 26 from its outer end 22 at least part way towards the inner end 18 of the nut body.

The frusto-conical seat 24 has a large diameter end 28 which extends radially beyond the polygonal main body portion 16. The diameter of the large diameter end is greater than the distance between opposite corners along a line passing through the axis 11 in a direction normal to the axis 11.

The frusto-conical seat 24 has the configuration best shown in FIG. 3. Adjacent the main body portion 16, a portion 30 of the frusto-conical seat 24 is recessed. The recessed portion 30 receives an end flange 32 of cap 12. The depth of recessed portion 30 is about equal to the thickness of metal used to form cap 12. The end flange 32 overlays recessed portion 30 and together with seat 24 defines a wheel nut seating surface 34.

There is a transition portion 36 between body portion 16 and frusto-conical seat 24 which circumscribes the end of polygonal main body portion 16 and defines a concavely radiused surface 38 which serves as a sealing surface for the O-ring seal 13. The radiused surface 38 transitions to a planar surface 40 normal to axis 11. The planar surface 40 extends radially outwardly to intersect a cylindrical surface 42 axially extending away from the large diameter end 28.

The cap 12 is formed of a corrosion resistant and decorative material, such as stainless steel. The cap 12 has an elongated side wall 50 and an end wall 52 closing the inner end of the cap. The outer end of the cap 12 is open. The end wall 52 has a marginal portion 53 which is at right angles to the axis 11 of the cap, and an outwardly domed central portion.

The side wall 50 of the cap is polygonal. More specifically, it is in the form of a regular six-sided polyhedron in which all six surfaces or flats 54 are identical and parallel to the axis 11 of the side wall 50 and in which the angles separating the six flats are all equal. The inside dimensions of the side wall 50 are slightly larger than the outside dimensions of the main body portion 16 of the nut to enable cap 12 to easily slip over nut 10.

The side wall 50 of the cap at the open end terminates in a radially outwardly flared circular marginal portion 56. The marginal portion 56 has a radial outwardly extending flange 58 and a skirt portion 60 concentric with the axis 11. Prior to fixing the cap 12 to the nut 10, the skirt portion 60 is cylindrical, and is of an internal diameter approximately equal to the diameter of the large diameter end.

The O-ring seal 13 provides a seal between the nut 10 and the cap 12. The O-ring seal 13 preferably is of circular cross-section and may be made of a suitable flexible, resilient, compressible material such as natural or synthetic rubber. Preferably the O-ring seal 13 is a silicone ring.

The O-ring seal 13 is slipped over the nut body 14 and placed on the concavely radiused surface 38. The surfaces 38 and 40 provide a circular ledge or shelf supporting the seal 13.

The cap is assembled on the nut by sleeving it over the main body portion 16 to the point where the flange 58 of the marginal portion 56 of the side wall 50 of the cap engages and presses upon the O-ring seal 13 throughout a full 360 degrees, substantially as shown in FIG. 3. The marginal portion 56 of the cap encircles the transition portion 36 of the nut, enclosing the cylindrical surface 42 of the transition portion 36 of the enlargement 28 throughout a full 360 degrees. The cap is, of course, turned about its axis 11 before assembly so that when assembled the flats and angles on the side wall 50 of the cap are aligned with and confront the flats and angles on the main body portion 16 of the nut.

To complete the assembly, the outer edge portion 72 of the cylindrical portion 60 of the outwardly flared marginal portion 56 of the cap is mechanically crimped over the transition portion 36 and recessed portion 30 at the same angle as the taper of the frusto-conical seat 24 so as to press radially inwardly and bear against the recessed portion 30 of seat 24.

The mechanical clinching of the parts together by crimping the outer edge portion 72 of the marginal portion of the cap over the recessed portion 30 improves axial retention by bringing the flange 58 of marginal portion 56 into contact with the recessed portion 30 of the frusto-conical seat 24, thereby defining a portion of seating surface 34. The crimping compresses the O-ring seal 13 radially inwardly and axially to press it between the radiused surface 38 and/or planar surface 40, and the flange 58. A sufficiently tight annular seal between the nut at these points and the flange 58 of the outwardly flared marginal portion 56 of the cap is thus provided throughout 360 degrees, preventing the entry of moisture into the space between the nut and the cap.

The alignment of flange 58 with the unrecessed portion of seat 24 enables flange to serve as an extension of the load bearing seating surface against a wheel, and potentially improving the retention of the cap 12 in the mounted condition.

The embodiments disclosed herein have been discussed for the purpose of familiarizing the reader with the novel aspects of the invention. Although preferred embodiments of the invention have been shown and disclosed, many changes, modifications and substitutions may be made by one having ordinarily skill in the art without necessarily departing from the spirit and scope of the invention as described in the following claims.

What is claimed is:

1. A capped wheel nut assembly comprising:
a metal nut and a metal cap oriented on a common axis;
the nut having an elongated internally threaded body provided with a polygonal side wall extending from a first end thereof toward a second end thereof;
the nut having a frusto-conical seat at the second end tapering from a small diameter end at a terminus of the second end to a large diameter end proximate to the polygonal side wall of the nut, and the large diameter end being greater in diameter than a distance between opposite corners of the side wall of the nut; the nut having an annular recess formed in the frusto-conical seat at the large diameter end and the frusto-conical seat defining at least in part a seating surface;
the cap having an elongated annular side wall of substantially the same polygonal form as the side wall of the nut;
the cap having an end wall closing a first end thereof and being open at a second end thereof;
the cap having a first flange extending radially outwardly beyond the side wall of the cap at the open second end of the cap;
the cap having a skirt portion axially extending from the first flange in a direction away from the side wall of the cap and the skirt portion having an internal diameter at least as large as the large diameter end of the frusto-conical seat of the nut;
the cap being sleeved over the nut with its side wall surrounding the side wall of the nut and with its end wall overlying the first end of the nut;
an O-ring seal compressed between the large diameter end and the first flange of the cap to provide an annular seal throughout 360 degrees preventing entry of moisture between the cap and the nut;
the skirt being crimped over and pressed against the recessed portion of the frusto-conical surface and the skirt defining at least in part a portion of the seating surface.

2. A capped wheel nut assembly as defined in claim 1, wherein the nut has a cylindrical portion disposed between the large diameter end and the polygonal side wall of the nut and the skirt portion has a corresponding cylindrical portion between the first flange and a part of the skirt crimped over the recessed portion.

3. A capped wheel nut assembly as defined in claim 2, wherein the nut has an annular radiused surface terminating radially outwardly in a planar surface, and the O-ring seal is compressed there against.
